(19) United States
(12) Patent Application Publication
(10) Pub. No.: US 2002/0097803 A1
(43) Pub. Date: Jul. 25, 2002

(54) Method for evaluating dynamic image code communications, and apparatus for evaluating the same

(76) Inventor: Yoshizo Honda, Tokyo (JP)

Correspondence Address: SAMUEL BORODACH, Fish & Richardson P.C., 45 Rockefeller Plaza, Suite 2800, New York, NY, 10111, US

(21) Appl. No.: 10/032,237

(22) Filed: Dec. 21, 2001

(30) Foreign Application Priority Data
Dec. 22, 2000 (JP) P2000-389795

(51) Int. Cl. H04N 7/12

(52) U.S. Cl. 375/240.29; 375/240.26

(57) ABSTRACT

A method for evaluating dynamic image code communications, which evaluates a defective amount of a dynamic image, which results from deterioration in transmission quality during transmissions, by a dynamic image code receiver that receives dynamic image codes transmitted from a dynamic image code transmitter through a communications network and decodes the same, is provided with the steps of: counting an amount of dynamic image codes, which are received for a specified period of time, and outputting the same; counting a defective amount for a specified period of time; and correcting the amount of the counted dynamic image code by the counted defective amount, and calculating an effective amount of dynamic image codes; wherein the effective amount of dynamic image codes is outputted as an evaluation value of dynamic image code communications.

### BACKGROUND OF THE INVENTION

1. Field of the Invention

The present invention relates to an apparatus for evaluating dynamic image code communications, and in particular to an apparatus for evaluating deterioration of after-transmission dynamic image quality in digital dynamic image code transmission and receiving.

2. Description of the Related Art

For this type of apparatus, there is an “apparatus for judging the quality in dynamic image transmission” according to Japanese Unexamined Patent Application Publication No. 15308 of 1999, which is filed by the same inventor.

Hereinafter, with respect to the above-described conventional art, a brief description is given of only the parts pertaining to the present invention. A digital dynamic image is a continuation of instantaneous pictures of a so-called dynamic frame (hereinafter called a “frame”).

Since a digital dynamic image is generally composed of a great deal of data, such dynamic image code transmission and receiving have been widely carried out, in which the data are transmitted after being compacted, that is, encoded by utilizing the statistical verbosity and characteristics of the sense of sight of a human who looks at the digital dynamic image and the dynamic image is reproduced by decompacting the data at the receiving side and decoding the data.

For example, as international standards for dynamic encoding, there are MPEG (Moving Picture Experts Group)-2 (ISO/IEC-13818), MPEG-4 (ISO/IEC-14496), which are prepared by the International Organization for Standardization, (named the “ISO”) and the IEC (International Electrotechnical Commission), and H.261 and H.263, which have been prepared by resolutions in of the ITU (International Telecommunications Union).

The present invention is applicable not only to the above-described international standards but also to dynamic image encoding equivalent thereto.

In the above-described International Standards, a dynamic frame is composed of pixels disposed in the form of a lattice and is divided into rectangles consisting of eight pixels in longitude x eight pixels in latitude, each of which is called a “block”. This frame is divided into rectangles consisting of 16 pixels in longitude×16 pixels in latitude, each of which is called a “macro block”.

Frequency constituents of the block are quantized and digitally encoded. Frequently, rough quantizing reduces the amount of codes.

With respect to a dynamic image frame close to a certain reference dynamic image frame in terms of time, a differential thereof from the reference dynamic image frame is encoded, and the differential is added to the dynamic image frame with reference to the encoded reference after transmission, that is, by synthesizing by addition, the dynamic image frame close to the reference in terms of time can be reproduced. This is called a “between-frame predicted encoding system”, in which there are some frames to which other frames are referred, and other frames in which no frame is referred to.

In addition thereto, such a type has been frequently employed, in which, with reference to a certain parameter, differentials are encoded in other frames. The amount of codes maybe reduced by frequently using the predicted encoding system. This may be called “improvement in the encoding efficiency.” On the other hand, if a reference value cannot be decoded due to an error in transmission as described below, other values that are permitted to be decoded on the basis of the reference value may not be decoded. Therefore, frequently the predicted encoding system is used, the omission of symbols due to an error in transmission may be increased.

In the above-described MPEG-4, the video object encoding system may be employed. For example, a picture showing a person pointing out an object and explaining it with a certain landscape in the background is transmitted with the person, the object and background are separately encoded one by one, and the original dynamic image is synthesized by decoding each of them after receiving. An objective that is separately encoded as described above is called a “video object”.

For example, the system is effective, in a case where the background is made into a remarkably rough dynamic image while the substance is made into the finest dynamic image.

The respective video objects are composed of a series of dynamic image frames in terms of time, wherein the respective frames are particularly called “video object planes” (simply called “VOP”).

Also, the time scalability encoding system is employed. Such that the above-described VOPs are thinned in terms of time to compose a dynamic image consisting of VOPs whose time interval is large, and these which are encoded are called “codes of the basic layer”.

In the VOP having a time interval before thinning so that a large time interval is filled up, a differential in the VOP immediately before that which is encoded, is called a “code of extended layers”.

At the receiving side, a dynamic image having rough time resolution power is reproduced by decoding the basic layer, and the extended layer is next decoded, whereby a dynamic image having high time resolution power is then reproduced. If the basic layer is reproduced even if the extended layer deteriorates, since it is possible to transmit a rough content of the picture, this is effective.

Also, a space scalability encoding system is employed. In respective dynamic image frames, changes in the graduation value of pixels disposed in the longitudinal and lateral directions are regarded as synthesization of a plurality of frequency constituents, and are called “changes in the spatial direction with respect to changes in time”.

Performance to dissect objects that differ in the respective dynamic image frames is called “space resolution power”. Those in which a dynamic image consisting of rough space resolution power is encoded are called “codes of the basic layer in space scalability”.

Such that encodes the differential between a dynamic image of the original detailed space resolution power and the basic layer so as to fill up rough space resolution power is called an “extended layer”. At the receiving side, the dynamic image of the rough space resolution power is decoded by decoding the basic layer, and next the extended layer is decoded and added or synthesized thereto, whereby a dynamic image having high space resolution power can be reproduced. If the basic layer can be reproduced even if the extended layer deteriorates, a rough content of the picture can be effectively transmitted.

A Japanese Unexamined Patent Application (Publication No. 10-108175) “Image code transmission system” made by the same inventor describes such a type that a picture is transmitted while being divided into simplified dynamic images, and the original dynamic image is synthesized on the basis of the respective simplified dynamic images to be decoded after they are received.

A“simplified dynamic image” is an image that, for example, respective dynamic image frames are divided into areas consisting of two pixels in longitude and two pixels in latitude and only one in the left upper area of the respective areas is left with all others thinned, wherein an image in which the space resolution power is made rough is obtained from the original dynamic image.

Also, the simplified dynamic image includes dynamic images composed of only the left lower area, right upper area or right lower area in addition to the above, and these partial dynamic images are also called a “simplified dynamic image”.

As long as all of the simplified dynamic images do not deteriorate, a rough content of the picture can be transmitted if only any one of the simplified dynamic images can be reproduced. This is effective.

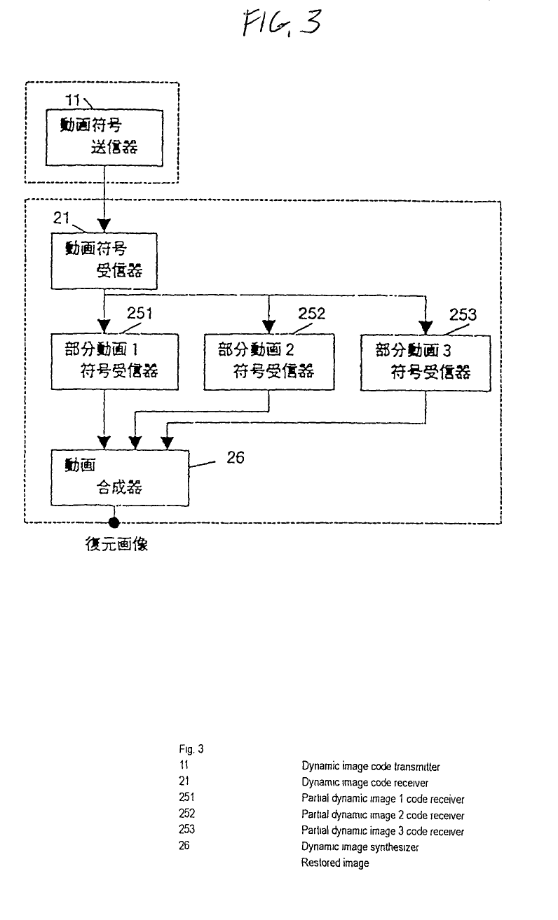

FIG. 3 shows a configuration for decoding such partial dynamic images.

A dynamic image code transmitter 11 transmits all partial dynamic image codes. A dynamic image code receiver 21 receives all or apart of the above-described partial dynamic image codes, and, after the dynamic image code receiver 21 divides the partial dynamic image codes into respective partial dynamic image codes, the dynamic image code receiver 21 distributes them to respective partial dynamic image code receivers 251, 252 and 253.

Herein, an example is shown, in which three partial dynamic image codes are received. However, there is a case where the dynamic image code receiver 21 receives only one partial dynamic image code.

For examples, there is a case is where the upper limit of the processing for receiving, decoding, reproduction and display is low, or there is a limitation due to a service contract. The case of receiving only the basic layer in the case of time scalability and space scalability corresponds to the above case.

Next, partial dynamic images that are received and decoded by the partial dynamic image code receivers 251, 252 and 253 are synthesized by a dynamic image synthesizer 26.

In the case of the video object code system, three video objects are, respectively, decoded by the partial dynamic image code receivers 251, 252 and 253.

The video objects are disposed by the dynamic image synthesizer 26 in display areas that are separately defined, wherein overlapping sections are displayed with only the front-most video objector may be synthesized through a weighting addition using a graduation value at an appointed weight.

In the case of the time scalability, the dynamic image of the basic layer is decoded by the partial dynamic image code receiver 251, the dynamic image of the next extended layer is decoded by the partial dynamic image code receiver 252, and the dynamic image of the further upper extended layer is decoded by the partial dynamic image code receiver 253.

In the dynamic image synthesizer 26, another frame that is obtained by adding the differential, which is decoded by the partial dynamic image code receiver 252, to the basic layer that is decoded by the partial dynamic image code receiver 251.

Further, still another frame is generated by adding the decoded differential of the upper extended layer, which is decoded by the partial dynamic image code receiver 253, to the above-described frame.

For example, in a case where the basic layer consists of five frames per second and the next extended layer consists of 10 frames per second, a frame belonging to the extended layer is generated between two frames belonging to the basic layer.

Further, in a case where the upper extended layer consists of thirty frames per second, two frames belonging to the upper extended layer are generated between two frames belonging to the immediately lower extended layer.

In the case of the space scalability, the dynamic images of the basic layer are decoded by the partial dynamic image code receiver 251, dynamic images of the next extended layer are decoded by the partial dynamic image code receiver 252, and dynamic images of the further upper extended layer are decoded by the partial dynamic image code receiver 253.

In the dynamic image synthesizer 26, a graduation value of the corresponding pixel is calculated from the screen of the basic layer decoded by the partial dynamic image code receiver 251, and the differential, which is decoded by the partial dynamic image code receiver 252, is added thereto.

Further, a graduation value of the corresponding pixel is calculated from the screen of the extended layer, which is decoded by the partial dynamic image code receiver 252, and the decoded differential of the upper extended layer that is decoded by the partial dynamic image code receiver 253 is added to the frame.

For example, in a case where the basic layer consists of 100 pixels in latitude and 50 pixels in longitude, and the next extended layer consists of 200 pixels in latitude and 100 pixels in longitude, the extended layer is divided into areas consisting of two pixels by two pixels, wherein pixels of the basic layer are repeatedly allocated in areas consisting of 100 pixels in latitude by 50 pixels in longitude, wherein the differential is added to the generated screen.

Further, this is the same in the case where the upper extended layer consists of 400 pixels in latitude by 200 pixels in longitude.

In the case of the simplified dynamic images, the respective simplified dynamic images are decoded by the partial dynamic image code receivers 251, 252 and 253.

In the dynamic synthesizer 26, a pixel to which another simplified dynamic image corresponds is newly inserted between the respective pixels, thereby synthesizing the original dynamic image.

Next, a description is given of quality deterioration in dynamic images due to transmission of the dynamic images. In the transmission and receiving of dynamic image codes, a case occurs, where the dynamic image that is reproduced at the receiving side is not coincident with the original dynamic image due to the following reasons, and the quality of the dynamic image deteriorates.

There is a case where a dynamic image code is not correctly received by an error in the transmission.

Also, there is a case where apart of the packets is omitted or lost halfway when a dynamic image is divided into packets for transmission.

Further, there is another case where the transmission and receiving take excessive time, a certain dynamic image frame is not displayed in time after being decoded, with respect to the timing of reproduction of the dynamic image that has already commenced, and the process is shifted to the next dynamic image frame, skipping the display of the dynamic image frame.

Thus, parts or points that cannot be decoded, displayed and reproduced with respect to the original dynamic image are called “defects”.

An object of an apparatus for evaluating dynamic image code communications is to quantitatively evaluate the deterioration or defects of dynamic images due to transmission.

In bits where the error in transmission is slight, the quality of the dynamic image that is reproduced will be influenced by at which part of the dynamic image code the error occurs.

For example, in a case where a transmission error occurs in a specified macro block, and the subsequent macro blocks are correctly decoded, in the frame in which no reference is made to others, only the macro block is made defective.

If any transmission error occurs in the codes expressing parameters pertaining to the entirety of a certain dynamic image frame, the entire frame cannot be decoded and is made defective. Also, an abnormality is extended to other frames that make reference to the frame.

Thus, there is no fixed relationship between the amount of bits of dynamic images, which are not used for decoding and reproduction due to a transmission error and/or delay, etc., and the amount of defectives in the dynamic images that have been decoded. Influence on the defectives of the dynamic images greatly changes, depending on the points or parts of the codes.

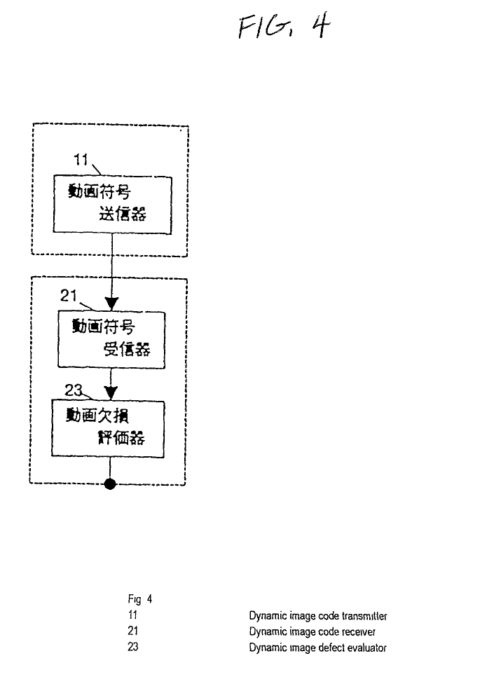

FIG. 4 shows a conventional art example of an apparatus for evaluating a dynamic image code communications for making the dynamic image defectives quantitative. The dynamic image code transmitter 11 encodes a dynamic image code and transmits the same. Next, the dynamic image code receiver 21 receives dynamic image codes transmitted by the dynamic image code transmitter 11 and decodes the above-described dynamic image codes for reproduction.

A dynamic image defective evaluator 23 detects an abnormality in the above-described decoding, and counts the size of the dynamic image defectives.

For example, it counts the frame defects, block defects, etc., which are not displayed, wherein, since the areas that are intended to be decoded with reference to the defective points or parts are not correctly decoded, they are handled as defects.

Next, a ratio of defects is calculated. The ratio of defects is a ratio that the defective amount of a dynamic image, which occurred for a specified period of time occupies the entirety of the dynamic image for a period of time.

For example, where 10 frames are made defective in 1,000 frames, the ratio of defects is 1%.

Or, where 10,000 pixels are made defective in 10,000,000 pixels for a period of time, the ratio of defects is 0.1%.

Since it is possible to reduce xxxxxx to the transmission quality of dynamic image codes so that the ratio of defects of the dynamic image codes can be lowered, this is effective with respect to a lowering of the ratio of defects.

In the conventional art, the transmission capacity of a communications network that transmits dynamic image codes is small in comparison with the amount of information of original dynamic images.

For example, dynamic images used for general television broadcasting are composed of approx. 100 Mbits per second where it is assumed that the dynamic images are of 500 pixels in latitude by 400 pixels in longitude, one pixel corresponds to color 16 bits, and 30 frames are transmitted per second.

If the capacity is encoded at a typical mean compacting ratio that is one-twentieth, the capacity becomes 4 Mbit/s. The capacity of a general consumer's telephone line is 100 kbit/s, which is remarkably low in a case of transmitting dynamic image codes having a satisfactory dynamic image quality.

Also, if a dynamic image is composed of 200 pixels in latitude by 150 pixels in longitude, one pixel corresponds to color 16 bits, and ten frames are transmitted per second, the capacity becomes 5 Mbit/s. Herein, if the quantizing is further roughed and the capacity is coded at the mean compacting ratio that is one-fiftieth, the capacity becomes approx. 100 kbit/s.

Thus, with the capacity of the general consumer's telephone line, the degree of resolution of a display screen is lowered, and the number of frames to be transmitted is made lower than the number of frames, which is necessary to reproduce smoothness of motions, in comparison with television broadcasting. This means that the capacity is able to be handled through telephone lines by general consumers, by roughing the quantization.

Since the quantizing roughness influences the quality in a dynamic image to be reproduced, the encoding is carried out at an encoding rate which is close to the transmission capacity permitted.

Thus, since the transmission capacity of a communications network is small in comparison with the amount of the typical dynamic image codes, the amount of dynamic image codes per second, that is, the code rate is a remarkably important parameter.

The major factors to determine the code rate of dynamic images are the number of pixels (screen size, or referred to as “resolution power”) in a screen, frame rate, number of graduations (number of colors), quantizing roughness, and encoding efficiency of an encoding system.

Herein, in order to increase the transmission capacity, it is necessary to note that the facility cost and running cost will be increased in proportion to an increase in the transmission capacity.

Consideration is taken with respect to the conditions of a service provider that provides the dynamic image distribution service with a charge through a communications network for general consumers.

If transmission service is carried out at a charge responsive to the amount of use and the quality of proposed dynamic images since the transmission capacity greatly influences the cost, it is possible to reduce the charge revenue in proportion to the transmission capacity and quality of dynamic images. Capacity-dependent charging in conventional data communications suits the object.

With respect to the object of carrying out such service, since a ratio of defects of dynamic images is outputted in a conventional art apparatus for evaluating dynamic image code communications, it is impossible to express a difference in the dynamic image quality, which depends on a code rate.

For example, where the ratio of defects of dynamic image codes of the above-described code rate 4 Mbit/s is 5%, and the ratio of defects of a dynamic image of a code rate 100 kbit/s is 5%, the evaluation value of the dynamic image quality becomes identical to each other. However, as described above, the former will have a very high dynamic image quality in terms of the degree of resolution and smoothness of actions.

Thus, there is such problem in that, with only the ratio of defects as in the conventional art apparatus for evaluating dynamic images, it is impossible to compare the dynamic image quality of dynamic image codes having greatly different code rates.

Also, as described above, with respect to the ratio of defect per video object, the ratio of defects of the entire video objects, the ratio of defects per layer in the time scalability, the ratio of defects of all the layers in the time scalability, the ratio of defects per layer in the space scalability, the ratio of defects of all the layers in the space scalability, the ratio of defects per simplified dynamic image, and the ratio of defects of all the simplified dynamic images, in almost all the cases, the higher the code rate becomes, the higher the quality becomes. Since no comparison can be carried out in situations where the code rates differ, there is a problem in that it is impossible to express the value of evaluation in response to the amount of use and quality of dynamic image.

### SUMMARY OF THE INVENTION

An object of the invention is to provide an apparatus for evaluating the quality of dynamic image code communications, which is capable of adequately evaluating the deterioration of dynamic image quality, after transmission, of dynamic image codes in which the amount of dynamic image information and amount of codes differ.

In order to solve the above-described object, a method for evaluating dynamic image code communications, which evaluates a defective amount of a dynamic image, which results from deterioration in transmission quality during transmissions, by a dynamic image code receiver that receives dynamic image codes transmitted from a dynamic image code transmitter through a communications network and decodes the same, comprises the steps of:

counting an amount of dynamic image codes, which are received for a specified period of time, and outputting the same;

counting a defective amount for a specified period of time; and

correcting the amount of the counted dynamic image code by the counted defective amount, and calculating an effective amount of dynamic image codes;

wherein, since the effective amount of dynamic image codes is outputted as an evaluation value of dynamic image code communications, it is possible to adequately evaluate the deterioration of the dynamic image quality, after transmission, of dynamic image codes in which the amount of dynamic image information and the amount of codes differ.

The method for evaluating dynamic image code communications, which evaluates a defective amount of a dynamic image, which results from deterioration in transmission quality during transmissions, by a dynamic image code receiver that receives dynamic image codes transmitted from a dynamic image code transmitter through a communications network and decodes the same, in which the dynamic image codes consist of partial dynamic image codes in which an original image is divided into a plurality of partial dynamic images and the respective dynamic images are encoded, comprises the steps of:

counting respective amounts of partial dynamic image codes that are received for a specified period of time, and outputting the same;

counting defective amounts of the partial dynamic images for a specified period of time;

correcting the amounts of the counted partial dynamic image codes by the respective partial defective amounts, and calculating effective amounts of the partial dynamic image codes;

calculating the entire amount of dynamic image codes by inputting the respective amounts of the partial dynamic image codes;

calculating the entire defective amount by inputting the respective defective amounts of the partial dynamic images; and

compensating the entire amount of dynamic image codes, which is calculated above, by the entire defective amount calculated above, and calculating the entire effective amount of dynamic image codes;

wherein, since the respective effective amounts of partial dynamic image codes and the entire effective amounts of dynamic image codes are outputted as evaluation values of dynamic image code communications, it is possible to obtain the amount of use of respective partial dynamic images, the partial dynamic image quality, the amount of use of the entire dynamic image and the quality thereof.

Since the partial dynamic images are respective objects according to a video object encoding system, it is possible to obtain the amount of use of respective video objects, the dynamic image quality, the amount of use of the entire dynamic image, and quality thereof.

Since the partial dynamic images are respective layers of a time scalability encoding system, it is possible to obtain the amount of use of respective layers, the dynamic image quality, the amount of use of the entire dynamic image, and dynamic image quality.

Since the partial dynamic images are respective layers of a space scalability encoding system, it is possible to obtain the amount of use of respective layers, the dynamic image quality, the amount of use of the entire dynamic image, and dynamic image quality.

Since the partial dynamic images are dynamic images, which are obtained by decomposing respective simplified dynamic images, it is possible to obtain the amount of use of respective simplified dynamic images, the partial dynamic image quality, the amount of use of the entire dynamic image, and dynamic image quality.

Since the method for evaluating dynamic image code communications comprises the step of calculating an amount of dynamic image information after being decoded, instead of the step of counting and outputting the amount of dynamic image codes that are received within the specified period of time, application of an encoding system having high encoding efficiency can be fostered in order to relieve the burden or load of a communications network.

Since the method for evaluating dynamic image code communications comprises the step of calculating an amount of quantized dynamic image information that are obtained by subtracting the defective amount from a product of an image size, number of frames, and number of graduation quantizing levels, instead of the step of counting and outputting the amount of dynamic image codes that are received with in the specified period of time, it is possible to obtain the dynamic image quality responsive to a dynamic image whose quantization is rough or a dynamic image whose quantization is fine.

The method for evaluating dynamic image code communications comprises the step of calculating a product of three factors consisting of an image size, number of frames, and a number of graduation quantized levels, after the three factors are provided with respective weights, and calculating an amount of modified quantized dynamic image information that is obtained by subtracting the defective amount from a product, instead of the step of counting and outputting the amount of dynamic image codes that are received within the specified period of time, wherein it is possible to obtain the quality of the dynamic image that intensively correlates to a dynamic image whose quantization is rough or a dynamic image whose quantization is fine.

An apparatus for evaluating dynamic image code communications, comprises:

means for receiving dynamic image codes;

means for counting and outputting the amount of dynamic image codes that are received for a specified period of time;

means for counting a defective amount for a specified period of time; and

means for compensating the counted amount of dynamic image codes by the counted defective amount and calculating an effective amount of dynamic image code information;

wherein, since the effective amount of dynamic image codes is outputted as an evaluation value of dynamic image code communications, it is possible to obtain an apparatus for evaluating dynamic image code communications, which is capable of adequately evaluating the deterioration of the dynamic image quality, after transmission, of dynamic image codes in which the amount of dynamic image information and the amount of codes differ.

An apparatus for evaluating dynamic image code communications, comprises:

means for dividing an original image into a plurality of partial dynamic images and receiving partial dynamic image codes in which the respective dynamic images are encoded;

means for counting the amounts of respective partial dynamic image codes that are received for a specified period of time, and for outputting the same;

means for counting the defective amounts of the respective partial dynamic images for a specified period of time;

means for correcting the counted amounts of respective partial dynamic image codes by the respective partial defective amounts, and for calculating an effective amount of partial dynamic image codes;

means for inputting the respective amounts of partial dynamic image codes and for calculating the entire amount of dynamic image codes;

means for inputting the defective amount of the respective partial dynamic images and for calculating the entire amount of dynamic image codes; and

means for correcting the calculated entire amount of dynamic image codes by the calculated entire defective amounts an for calculating the entire effective amount of dynamic image codes;

wherein, since the respective effective amounts of partial dynamic image codes and the entire effective amount of dynamic image codes are outputted as an evaluation value of dynamic image code communications, it is possible to obtain an apparatus for evaluating dynamic image code communications, which can output the amount of use of respective partial dynamic images, the dynamic image quality, the entire amount of use of dynamic images, and dynamic image quality thereof.

Since the partial dynamic images are respective objects according to a video object encoding system, it is possible to obtain the amount of use of respective video objects, the dynamic image quality, the amount of use of the entire dynamic image, and quality thereof.

Since the partial dynamic images are respective layers of a time scalability encoding system, it is possible to obtain the amount of use of respective layers, the dynamic image quality, the amount of use of the entire dynamic image, and dynamic image quality.

Since the partial dynamic images are respective layers of a space scalability encoding system, it is possible to obtain the amount of use of respective layers, the dynamic image quality, the amount of use of the entire dynamic image, and dynamic image quality.

Since the partial dynamic images are dynamic images, which are obtained by decomposing respective simplified dynamic images, it is possible to obtain the amount of use of respective simplified dynamic images, the partial dynamic image quality, the amount of use of the entire dynamic image, and dynamic image quality.

The apparatus for evaluating dynamic image code communications comprises the means for calculating an amount of dynamic image information after being decoded, instead of the means for counting and outputting the amount of dynamic image codes that are received within the specified period of time. Therefore, application of an encoding system having high encoding efficiency can be fostered in order to relieve the burden or load of a communications network.

The apparatus for evaluating dynamic image code communications comprises the means for calculating an amount of quantized dynamic image information that is obtained by subtracting the defective amount from a product of an image size, number of frames, and number of graduation quantizing levels, instead of the means for counting and outputting the amount of dynamic image codes that are received within the specified period of time. Therefore, it is possible to obtain the quality of dynamic image quality responsive to a dynamic image whose quantization is rough or a dynamic image whose quantization is fine. The apparatus for evaluating dynamic image code communications comprises the means for calculating a product of three factors consisting of an image size, number of frames, and a number of graduation quantized levels, after the three factors are provided with respective weights, and calculating an amount of modified quantized dynamic image information that is obtained by subtracting the defective amount from a product, instead of the means for counting and outputting the amount of dynamic image codes that are received within the specified period of time. Therefore, it is possible to obtain dynamic image qualities that intensively correlate to a dynamic image whose quantization is rough or a dynamic image whose quantization is fine.

### BRIEF DESCRIPTION OF THE INVENTION

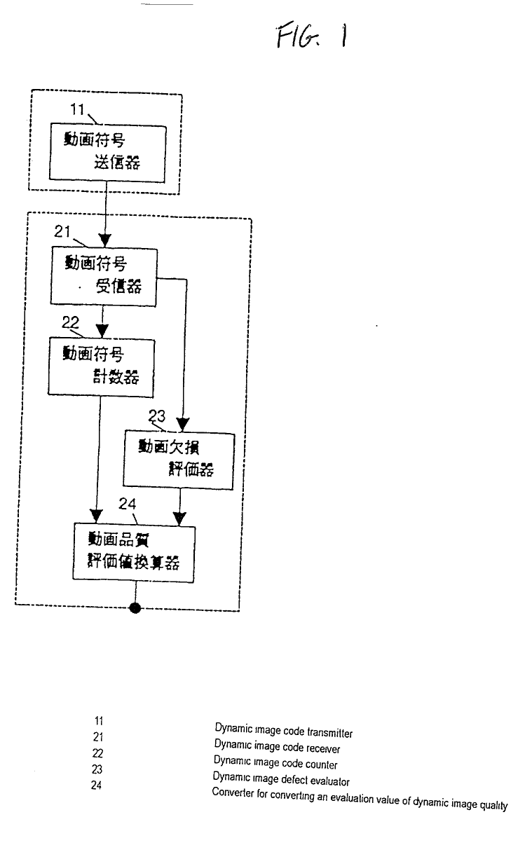

FIG. 1 is a block diagram showing a configuration of an apparatus according to a first embodiment of the invention.

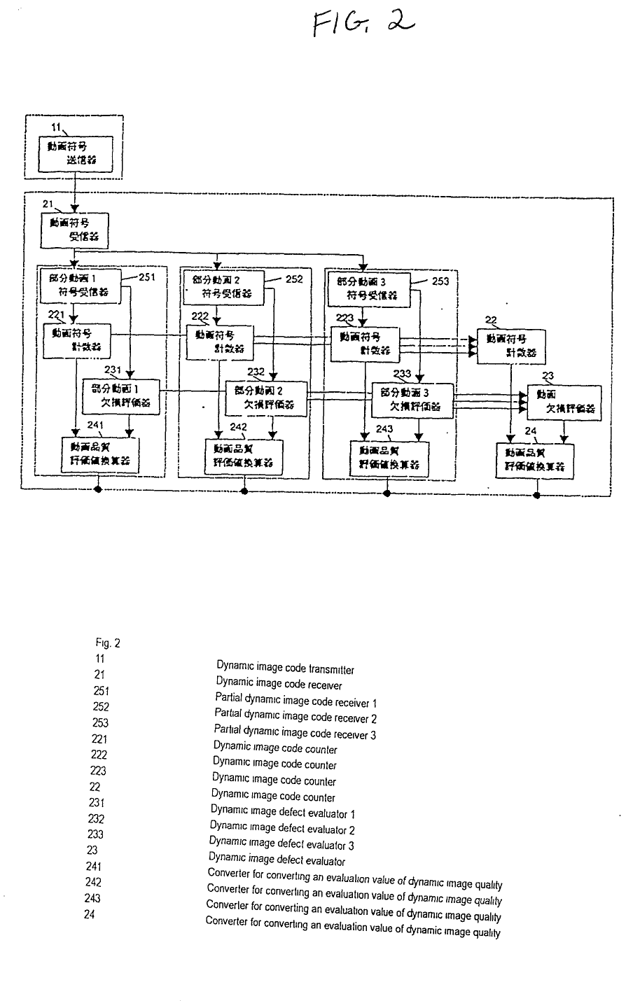

FIG. 2 is a block diagram showing a configuration of an apparatus according to a second embodiment of the invention.

FIG. 3 is a block diagram showing the configuration of a receiver that receives partial dynamic image codes.

FIG. 4 is a view explaining a conventional art example.

### DETAILED DESCRIPTION OF THE PRESENT INVENTION

Next, a description is given of embodiments of the invention with reference to the accompanying drawings.

FIG. 1 is a block diagram showing a configuration of an apparatus according to an embodiment of the invention.

A dynamic image code transmitter 11 transmits, although not being illustrated, dynamic image codes to a dynamic image signal receiver 21 through a communications network.

A dynamic image code receiver 21 receives the above-described dynamic image codes and decodes the same.

If any abnormality occurs in the dynamic image codes when decoding the same, the dynamic image code receiver 21 outputs an abnormality detection signal, and inputs it into a dynamic image defective evaluator 23 or the dynamic image defect evaluator 23 detects the abnormality.

Herein, the principle, configuration and action of the dynamic image defect evaluator 23 are described in Japanese Unexamined Patent Application Publication No. 11-153078 carrying the title of “Apparatus for judging dynamic image communications quality”. However, the evaluator 23 is briefly described below.

The dynamic image defect evaluator 23 counts abnormal areas, that is, defective areas.

This is a method that records the areas that have been correctly decoded, and regards areas, which are not recorded as shown above, as abnormal or defective areas.

The counting is carried out in units of pixels, blocks, macro blocks, and frames. If other areas are based on reference to defective areas even if they are not directly defective areas, they are influenced by the defective areas, wherein the areas to be decoded with reference to the defective areas are counted as defective areas.

Further, the evaluator 23 outputs the ratio of the defective areas to the entirety within a defined period of time as the ratio of defects.

Dynamic image codes that are received by the dynamic image code receiver 21 are inputted into a dynamic image code counter 22, and the dynamic image code counter 22 counts the amount of dynamic image codes for the same period of time as described above, and outputs it.

A converter 24 for converting an evaluation value of dynamic image quality receives the above-described ratio of defects and the amount of the dynamic image codes as inputs, and proportionally compensates the above-described amount of the dynamic image codes by using the above-described ratio of defects and outputs an effective amount of dynamic image codes.

For example, in a case where the amount of dynamic image codes is 4 Mbit for a specified second and the ratio of defects is 5%, the effective amount of dynamic image codes becomes 4 Mbit ×(1-0.05)=3.8 Mbit.

In another example, in a case where the amount of dynamic image codes is 100 kbit for a specified second and the ratio of defects is 5%, the effective amount of dynamic image codes becomes 100kbit×(1-0.05)=95 Mbit.

Thus, in the same ratios of defects, the dynamic image quality of the former case is higher than that of the latter a case. In an extreme example, it is reasonable in view of the amount of use in the form of the amount of communications that a case where the ratio of defects is 50% with respect to dynamic image codes of 4 Mbit/s and a case where the ratio of defects is 0% with respect to dynamic image codes of 2 Mbit/s are equivalently charged.

Therefore, the effective amount of dynamic image codes is effective as a quality evaluation value for charging.

In a case where the communications qualities of dynamic image codes having remarkable differences in the encoding efficiency are compared with each other, the code rate is not an adequate measure.

Where the capacity of transmission is sufficient and the processing rate of a receiver is emphasized, the amount of dynamic image information is made important.

Herein, the amount of decoded dynamic image information is used. The amount of the decoded dynamic image information is compensated by the ratio of defects regardless of the quantizing roughness and code rate.

For example, where it is assumed that the decoded pixels consist of 500 pixels in latitude by 400 pixels in longitude, one pixel corresponds to color 16 bits, and are transmitted at a rate of 30 frames per second, the amount of dynamic image information per specified second becomes approx. 100 Mbit.

In this case, if the ratio of defects is 5%, the effective amount of dynamic image information becomes 100 Mbit×(1-0.05) =95 Mbit.

In another example, where it is assumed that the decoded pixels consist of 200 pixels in latitude by 150 pixels in longitude, one pixel corresponds to color 16 bits, and are transmitted at a rate of 10 frames per second, the amount of dynamic image information per specified second becomes approx. 5 Mbit. In this case, if the ratio of defects is 5%, the effective amount of dynamic image information becomes 5 Mbit×(1-0.05)=4.75 Mbit.

In this case, the dynamic image quality of the former case is higher than that of the latter case even if the ratios of defects are identical to each other.

In an extreme example in which a case where the ratio of defects is 50% when dynamic images of 100 Mbit are obtained after being decoded, and a case where the ratio of defects is 0% when dynamic images of 50 Mbit are obtained after being decoded, there is another viewpoint where almost the same charge is charged, provided that the amount of the obtained information is almost the same even if the picture size, frame rate, code rate, etc., are different from each other.

In this case, the burden or load of communications capacity is further relieved when a system having a higher coding efficiency is employed. Therefore, such an action is brought about, by which improvement of the coding system is fostered.

In the configuration of an apparatus to use the amount of decoded dynamic image information, the above-described dynamic image code counter 22 calculates the amount of decoded dynamic image information on the basis of picture size, frame rate, number of graduation levels (number of colors), etc., instead of counting the dynamic image codes in the above description.

In the converter 24 for converting an evaluation value of the dynamic image quality, the action of proportionally compensating on the basis of the ratio of defects is the same as above.

In particular, the above-described dynamic image code counter 22 calculates the product of the three consisting of the picture size, frame rate and number of quantizing graduation levels as a value, which is herein called an “amount of quantizing dynamic image information”, instead of counting the dynamic image codes in the above description.

If the number of graduation levels that can be displayed by a receiver is great and the number of graduation levels, which has been quantized when encoding, is small, the amount of data is slight as the amount of dynamic image information.

Also, in this case, a value which is reflected by a general tendency in that the rougher the quantization becomes, the further the quality is lowered will be obtained.

In the converter 24 for converting an evaluation value of dynamic image quality, a value that is obtained by subtracting the amount of defects from the above-described amount of quantizing dynamic image information is regarded as the evaluation value of the dynamic image codes. Herein, the amount of defects may be calculated as in the above.

Further, the above-described dynamic image code counter 22 calculates the product of the three figures, which are obtained by weighting the three consisting of the picture size, frame rate and number of quantizing graduation levels, instead of counting the dynamic image codes. The product is herein called an “amount of corrected quantizing dynamic image information”.

In the converter 24 for converting an evaluation value of dynamic image quality, the value that is obtained by subtracting the amount of defects from the above-described amount of corrected quantizing dynamic image information is regarded as the evaluation value of dynamic image codes. Herein, the calculation of the amount of defects may be carried out as in the above.

However, where the noted dynamic image consists of a plurality of partial dynamic images, for example, three partial dynamic images, the configuration shown in FIG. 2 is embodied.

The configuration and actions of the dynamic image code transmitter 11, dynamic image code receiver 21, partial dynamic image code receivers 251, 252 and 253, which are shown in FIG. 2, are similar to those in FIG. 3.

The partial dynamic image code counters 221, 222 and 223 shown in FIG. 2 have the same actions as those of the dynamic image code counter 22 shown in FIG. 1. The counters 221, 222 and 223 count partial dynamic images in a specified range of partial dynamic images, and outputs the results of the counting to the dynamic image code counter 22 of FIG. 2.

The partial dynamic image defect evaluators 231, 232 and 233 of FIG. 2 have the same actions as those of the dynamic image defect evaluator of FIG. 1, and evaluate defects in a specified range of partial dynamic images. The evaluators 231, 232 and 233 further output the results of the evaluation to the dynamic image defect evaluator 23 of FIG. 2.

Since, in the time scalability and space scalability, defects in further lower layers influence the immediately upper layers, if the referred lower layer is defective, the upper layer is considered to be defective.

The converters 241, 242 and 243 for converting evaluation values of dynamic image qualities have the same actions as those of the converter 24 for converting an evaluation value of dynamic image quality.

The dynamic image code counter 22 of FIG. 2 adds the outputs from the partial dynamic image code counters 221, 222 and 223, and outputs the results to the converter 24 for converting the evaluation value of the dynamic image quality.

The dynamic image defect evaluator 23 of FIG. 2 adds the outputs of the partial dynamic image defect evaluators 231, 232 and 233 and outputs the results to the converter 24 for converting an evaluation value of dynamic image quality.

The converter 24 for converting an evaluation value of dynamic image quality of FIG. 2 has the same action as that of the converter 24 for converting an evaluation value of dynamic image quality of FIG. 1.

Since some of the receivers receive only one of the above-described basic layers and simplified dynamic images or processes only a part of the partial dynamic images, the evaluation value of the respective partial dynamic images can be obtained by the configuration shown in FIG. 2.

In addition, since it is possible to reduce xxxxxx to the transmission quality of partial dynamic image codes so that the ratio of defects of the partial dynamic image codes can be lowered, this is effective with respect to a lowering of the ratio of defects. Furthermore, since the evaluation of the entirety of dynamic image can be obtained, this is effective to totally lower the defects.

The first aspect of the invention is a method for evaluating dynamic image code communications, which evaluates a defective amount of a dynamic image, which results from deterioration in transmission quality during transmissions, by a dynamic image code receiver that receives dynamic image codes transmitted from a dynamic image code transmitter through a communications network and decodes the same, comprises the steps of:

counting an amount of dynamic image codes, which are received for a specified period of time, and outputting the same;

counting a defective amount for a specified period of time; and

correcting the amount of the counted dynamic image code by the counted defective amount, and calculating an effective amount of dynamic image codes;

wherein, since the effective amount of dynamic image codes is outputted as an evaluation value of dynamic image code communications, it is possible to adequately evaluate the deterioration of the dynamic image quality, after transmission, of dynamic image codes in which the amount of dynamic image information and the amount of codes differ. Therefore, it is possible to compare dynamic images having different code rates with each other in terms of quality, and it is effective to determine charges in response to the amount of use and the quality of dynamic images.

The second aspect of the invention is a method for evaluating dynamic image code communications, which evaluates a defective amount of a dynamic image, which results from deterioration in transmission quality during transmissions, by a dynamic image code receiver that receives dynamic image codes transmitted from a dynamic image code transmitter through a communications network and decodes the same, in which the dynamic image codes consist of partial dynamic image codes in which an original image is divided into a plurality of partial dynamic images and the respective dynamic images are encoded, comprises the steps of:

counting respective amounts of partial dynamic images that are received for a specified period of time, and outputting the same;

counting defective amounts of the partial dynamic images for a specified period of time;

correcting the amounts of the counted partial dynamic image codes by the respective partial defective amounts, and calculating effective amounts of the partial dynamic image codes;

calculating the entire amount of dynamic images by inputting the respective amounts of the partial dynamic image codes;

calculating the entire defective amount by inputting the respective defective amounts of the partial dynamic images; and

compensating the entire amount of dynamic image codes, which is calculated above, by the entire defective amount calculated above, and calculating the entire effective amount of dynamic image codes;

wherein, since the respective effective amounts of partial dynamic image codes and the entire effective amounts of dynamic image codes are outputted as evaluation values of dynamic image code communications, it is possible to obtain the amount of use of respective partial dynamic images, the partial dynamic image quality, the amount of use of the entire dynamic image and the quality thereof. Therefore, the aspect is effective to determine charges in response to the amount of use and quality of dynamic images in both a case where only partial dynamic images are utilized and a case where the entirety of dynamic images is utilized.

The third aspect of the invention is such that, since the partial dynamic images are respective objects according to a video object encoding system, it is possible to obtain the amount of use of respective video objects, the dynamic image quality, the amount of use of the entire dynamic image, and quality thereof. Therefore, the aspect is effective to determine charges in response to the amount of use and quality of dynamic images in both a case where specified video objects are utilized and a case where the entirety of dynamic images is utilized.

The fourth aspect of the invention is such that, since the partial dynamic images are respective layers of a time scalability encoding system, it is possible to obtain the amount of use of respective layers, the dynamic image quality, the amount of use of the entire dynamic image, and dynamic image quality. Therefore, the aspect is effective to determine charges in response to the amount of use and quality of dynamic images in both a case where only the basic layer is utilized and a case where the entirety of dynamic images is utilized.

The fifth aspect of the invention is such that, since the partial dynamic images are respective layers of a space scalability encoding system, it is possible to obtain the amount of use of respective layers, the dynamic image quality, the amount of use of the entire dynamic image, and dynamic image quality. Accordingly, the aspect is effective to determine charges in response to the amount of use and quality of dynamic images in both a case where only the basic layer is utilized and a case where the entirety of dynamic images is utilized.

The sixth aspect of the invention is such that, since the partial dynamic images are dynamic images, which are obtained by decomposing respective simplified dynamic images, it is possible to obtain the amount of use of respective simplified dynamic images, the partial dynamic image quality, the amount of use of the entire dynamic image, and dynamic image quality. Therefore, the aspect is effective to determine charges in response to the amount of use and quality of dynamic images in both a case where only the simplified dynamic images are utilized and a case where the entirety of dynamic images is utilized.

The seventh aspect of the invention is such that, since the method for evaluating dynamic image code communications comprises the step of calculating an amount of dynamic image information after being decoded, instead of the step of counting and outputting the amount of dynamic image codes that are received within the specified period of time, application of an encoding system having high encoding efficiency can be fostered in order to relieve the burden or load of a communications network. Therefore, such an effect can be brought about, by which the application of an encoding system having high encoding efficiency can be fostered in order to relieve the burden or load of communications lines.

The eighth aspect of the invention is such that, since the method for evaluating dynamic image code communications comprises the step of calculating an amount of quantized dynamic image information that are obtained by subtracting the defective amount from a product of an image size, number of frames, and number of graduation quantizing levels, instead of the step of counting and outputting the amount of dynamic image codes that are received within the specified period of time, it is possible to obtain dynamic image qualities responsive to a dynamic image whose quantization is rough or a dynamic image whose quantization is fine. Therefore, such an effect can be brought about, by which a dynamic image quality can be obtained in response to the qualities of roughly quantized dynamic images and finely quantized dynamic images.

The ninth aspect of the invention is the method for evaluating dynamic image code communications that comprises the step of calculating a product of three factors consisting of an image size, number of frames, and a number of graduation quantized levels, after the three factors are provided with respective weights, and calculating an amount of modified quantized dynamic image information that is obtained by subtracting the defective amount from a product, instead of the step of counting and outputting the amount of dynamic image codes that are received within the specified period of time. Such an effect can be brought about, by which it is possible to obtain dynamic image qualities that intensively correlate to a dynamic image whose quantization is rough or a dynamic image whose quantization is fine.

Further, the tenth aspect of the invention is an apparatus for evaluating dynamic image code communications that comprises:

means for receiving dynamic images codes;

means for counting and outputting the amount of dynamic image codes that are received for a specified period of time;

means for counting a defective amount for a specified period of time; and

means for compensating the counted amount of dynamic image codes by the counted defective amount and calculating an effective amount of dynamic image codes;

wherein, since the effective amount of dynamic image codes is outputted as an evaluation value of dynamic image codes, it is possible to obtain an apparatus for evaluating dynamic image code communications, which is capable of adequately evaluating the deterioration of the dynamic image quality, after transmission, of dynamic image codes in which the amount of dynamic image information and the amount of codes differ and to compare the quality of dynamic image codes in which the code rates differ. Therefore, the aspect is effective to determine charges in response to the amount of use and quality of dynamic images.

The eleventh aspect of the invention is an apparatus for evaluating dynamic image code communications that comprises:

means for dividing an original image into a plurality of partial dynamic images and receiving partial dynamic image codes in which the respective dynamic images are encoded;

means for counting the amounts of respective partial dynamic image codes that are received for a specified period of time, and for outputting the same;

means for counting the defective amounts of the partial dynamic images for a specified period of time;

means for correcting the counted amounts of respective partial dynamic image codes by the respective partial defective amounts, and for calculating an effective amount of partial dynamic image codes;

means for inputting the respective amounts of partial dynamic image codes and for calculating the entire defective amount;

means for inputting the defective amounts of the above-described partial dynamic images and for calculating the entire amount of detects; and

means for correcting the calculated entire amount of dynamic image codes by the calculated entire defective amounts and for calculating the entire effective amount of dynamic image codes;

wherein, since the respective effective amounts of partial dynamic image codes and the entire effective amount of dynamic image codes are outputted as an evaluation value of dynamic image code communications, it is possible to obtain an apparatus for evaluating dynamic image code communications, which can output the amount of use of respective partial dynamic images, the dynamic image quality, the entire amount of use of dynamic images, and dynamic image quality thereof. Therefore, the aspect is effective to determine charges in response to the amount of use and quality of dynamic image in both a case where only the partial dynamic images are utilized and a case where the entirety of dynamic images is utilized.

The twelfth aspect of the invention is such that, since the partial dynamic images are respective objects according to a video object encoding system, it is possible to obtain the amount of use of respective video objects, the dynamic image quality, the amount of use of the entire dynamic image, and quality thereof. Therefore, the aspect is effective to determine charges in response to the amount of use and quality of dynamic image in both a case where specified video objects are utilized and a case where the entirety of dynamic images is utilized.

The thirteenth aspect of the invention is such that, since the partial dynamic images are respective layers of a time scalability encoding system, it is possible to obtain the amount of use of respective layers, the dynamic image quality, the amount of use of the entire dynamic image, and dynamic image quality thereof. Therefore, the aspect is effective to determine charges in response to the amount of use and quality of dynamic image in both a case where only the basic layer is utilized and a case where the entirety of dynamic images is utilized.

Also, the fourteenth aspect of the invention is such that, since the partial dynamic images are respective layers of a space scalability encoding system, it is possible to obtain the amount of use of respective layers, the dynamic image quality, the amount of use of the entire dynamic image, and dynamic image quality thereof. Therefore, the aspect is effective to determine charges in response to the amount of use and quality of dynamic image in both a case where only the basic layer is utilized and a case where the entirety of dynamic images is utilized.

The fifteenth aspect of the invention is such that, since partial dynamic images are dynamic images, which are obtained by decomposing respective simplified dynamic images, it is possible to obtain the amount of use of respective simplified dynamic images, the dynamic image quality, the amount of use of the entire dynamic image, and dynamic image quality thereof. The aspect is effective to determine charges in response to the amount of use and quality of dynamic image in both a case where only the simplified dynamic images are utilized and a case where the entirety of dynamic images is utilized.

In addition, the sixteenth aspect of the invention is an apparatus for evaluating dynamic image code communications that comprises the means for calculating an amount of dynamic images after being decoded, instead of the means for counting and outputting the amount of dynamic images that are received within the specified period of time. Therefore, application of an encoding system having high encoding efficiency can be fostered in order to relieve the burden or load of a communications network. Therefore, such an effect can be brought about, by which application of an encoding system having high encoding efficiency can be fostered in order to relieve the burden or load of a communications network.

Still further, the seventeenth aspect of the invention is the apparatus for evaluating dynamic image code communications that comprises the means for calculating an amount of quantized dynamic images that are obtained by subtracting the defective amount from a product of an image size, number of frames, and number of graduation quantizing levels, instead of the means for counting and outputting the amount of dynamic image codes that are received within the specified period of time. Therefore, since it is possible to obtain dynamic image qualities responsive to a dynamic image whose quantization is rough or a dynamic image whose quantization is fine, such an effect can be brought about, by which dynamic image qualities responsive to a dynamic image whose quantization is rough or a dynamic image whose quantization is fine can be obtained.

The eighteenth aspect of the invention is the apparatus for evaluating dynamic image code communications that comprises the means for calculating a product of three factors consisting of an image size, number of frames, and a number of graduation quantized levels, after the three factors are provided with respective weights, and calculating an amount of modified quantized dynamic information that is obtained by substracting the defective amount from a product, instead of the means for counting and outputting the amount of dynamic images that are received within the specified period of time. Therefore, it is possible to obtain dynamic image qualities that intensively correlate to dynamic image whose quantization is rough or a dynamic image whose quantization is fine.

What is claimed is:

1. A method for evaluating dynamic image code communications, the method comprising the steps of:
receiving dynamic image codes transmitted through a communications network;
decoding the dynamic image codes;
counting an amount of the dynamic image codes received for a specified period of time;
outputting the amount of the dynamic image codes;
counting a defective amount of the dynamic image codes for the specified period of time; and
correcting the amount of the counted dynamic image code according to the counted defective amount to calculate an effective amount of the dynamic image codes; and
outputting the effective amount of the dynamic image codes as an evaluation value of the dynamic image code communications.

2. The method as set forth in claim 1, wherein the defective amount of the dynamic image codes results from deterioration in transmission quality during transmissions.

3. The method as set forth in claim 1, further comprising:
calculating an amount of dynamic image information after being decoded, instead of the step of counting and outputting the amount of dynamic images received within the specified period of time.

4. The method as set forth in claim 1, further comprising:
subtracting the defective amount from a product of an image size, number of frames, and number of graduation quantizing levels to calculate an amount of quantized dynamic image information, instead of the step of counting and outputting the amount of dynamic image codes received within the specified period of time.

5. The method as set forth in claim 1, further comprising:
calculating a product of three factors of an image size, number of frames, and a number of graduation quantized levels after the three factors are provided with respective weights; and
subtracting the defective amount from the product to calculate an amount of modified quantized dynamic image information,
instead of the step of counting and outputting the amount of dynamic image codes that are received within the specified period of time.

6. A method for evaluating dynamic image code communications using dynamic image codes, in which an original image is divided into a plurality of partial dynamic images and the respective dynamic images are encoded, the method comprising the steps of:
receiving dynamic image codes transmitted through a communications network;
decoding the dynamic image codes;
counting an amount of each of the partial dynamic images received for a specified period of time;
outputting the amount of each of the partial dynamic images;
counting a defective amount of each of the partial dynamic images for the specified period of time;
correcting the amount of each of the counted partial dynamic image codes by the corresponding defective amount thereof to calculate an effective amount of each of the partial dynamic image codes;
inputting the respective amounts of the partial dynamic image codes to calculate the entire amount of dynamic image codes;
inputting the respective defective amounts of the partial dynamic images to calculate the entire defective amount of;
compensating the entire amount of dynamic image codes according to the entire defective amount and to calculate the entire effective amount of dynamic image codes; and
outputting the respective effective amounts of partial dynamic image codes and the entire effective amounts of dynamic image codes as evaluation values of dynamic image code communications.

7. The method as set forth in claim 6, wherein the defective amount of the dynamic image codes results from deterioration in transmission quality during transmissions.

8. The method as set forth in claim 6, wherein by a dynamic image code receiver receives the dynamic image codes transmitted from a dynamic image code transmitter through a communications network, and the dynamic image code receiver decodes the dynamic image codes.

9. The method as set forth in claim 6, wherein the partial dynamic images are respective objects according to a video object encoding system.

10. The method as set forth in claim 6, wherein the partial dynamic images are respective layers of a time scalability encoding system.

11. The method as set forth in claim 6, wherein the partial dynamic images are respective layers of a space scalability encoding system.

12. The method as set forth in claim 6, wherein the partial dynamic images are dynamic images, and obtained by decomposing respective simplified dynamic images.

13. The method as set forth in claim 6, further comprising:
calculating an amount of dynamic image information after being decoded, instead of the step of counting and outputting the amount of dynamic images received within the specified period of time.

14. The method as set forth in claim 6, further comprising:
subtracting the defective amount from a product of an image size, number of frames, and number of graduation quantizing levels to calculate an amount of quantized dynamic image information, instead of the step of counting and outputting the amount of dynamic image codes received within the specified period of time.

15. The method as set forth in claim 6, further comprising:
calculating a product of three factors of an image size, number of frames, and a number of graduation quantized levels after the three factors are provided with respective weights; and
subtracting the defective amount from the product to calculate an amount of modified quantized dynamic image information, instead of the step of counting and outputting the amount of dynamic image codes that are received within the specified period of time.

16. An apparatus for evaluating dynamic image code communications, the apparatus comprising:
a receiver for receiving dynamic image codes;
a counter for counting and outputting the amount of the dynamic image codes received for a specified period of time;
a defective amount counter for counting a defective amount of the dynamic image codes for the specified period of time; and
a compensator for compensating the counted amount of dynamic images according to the counted defective amount and calculating an effective amount of dynamic image codes;
wherein the effective amount of dynamic image codes is outputted as an evaluation value of dynamic image code communications.

17. The apparatus as set forth in claim 16, comprising a calculator for calculating an amount of dynamic image information after being decoded, instead of the counter.

18. The apparatus as set forth in claim 16, comprising a calculator for calculating an amount of quantized dynamic image information obtained by subtracting the defective amount from a product of an image size, number of frames, and number of graduation quantizing levels, instead of the counter.

19. The apparatus as set forth in claim 16, comprising a calculator for calculating a product of three factors consisting of an image size, number of frames, and a number of graduation quantized levels, after the three factors are provided with respective weights, and calculating an amount of modified quantized dynamic image information that is obtained by subtracting the defective amount from the product, instead of the counter.

20. An apparatus for evaluating dynamic image code communications, the apparatus comprising:
a receiver for receiving partial dynamic image codes in which an original image is divided into a plurality of partial dynamic images and the respective dynamic images are encoded;
a counter for counting the amounts of respective partial dynamic image codes received for a specified period of time, and outputting the amounts of the respective partial dynamic image;
a defective amount counter for counting the defective amounts of the partial dynamic images for the specified period of time;
a first compensator for correcting the counted amounts of respective partial dynamic image codes by the respective partial defective amount, and calculating an effective amount of partial dynamic image codes;
a first calculator for inputting the respective amounts of partial dynamic image codes to calculate the entire amount of dynamic image codes;
a second calculator for inputting the defective amount of the respective partial dynamic images to calculate the entire defective amount; and
a second compensator for correcting the calculated entire amount of dynamic image codes according to the calculated entire defective amount to calculate the entire effective amount of dynamic image codes;
wherein the respective effective amounts of partial dynamic image codes and the entire effective amount of dynamic image codes are outputted as an evaluation value of dynamic image code communications.

21. The apparatus as set forth in claim 20, wherein the partial dynamic images are respective objects according to a video object encoding system.

22. The apparatus as set forth in claim 20, wherein the partial dynamic images are respective layers of a time scalability encoding system.

23. The apparatus as set forth in claim 20, wherein the partial dynamic images are respective layers of a space scalability encoding system.

24. The apparatus as set forth in claim 20, wherein the partial dynamic images are dynamic images, obtained by decomposing respective simplified dynamic images.

25. The apparatus as set forth in claim 20, comprising a third calculator for calculating an amount of dynamic image information after being decoded, instead of the counter.

26. The apparatus as set forth in claim 20, comprising a third calculator for calculating an amount of quantized dynamic image information obtained by subtracting the defective amount from a product of an image size, number of frames, and number of graduation quantizing levels, instead of the counter.

27. The apparatus as set forth in claim 20, comprising a third calculator for calculating a product of three factors consisting of an image size, number of frames, and a number of graduation quantized levels, after the three factors are provided with respective weights, and calculating an amount of modified quantized dynamic image information that is obtained by subtracting the defective amount from the product, instead of the counter.
